(19) United States
(12) Patent Application Publication
(10) Pub. No.: US 2019/0146567 A1
(43) Pub. Date: May 16, 2019

(54) PROCESSOR THROTTLING BASED ON ACCUMULATED COMBINED CURRENT MEASUREMENTS

(71) Applicant: ADVANCED MICRO DEVICES, INC., Sunnyvale, CA (US)

(72) Inventors: Stephen Victor KOSONOCKY, Fort Collins, CO (US); Larry D. HEWITT, Austin, TX (US); Erik SWANSON, Fort Collins, CO (US)

(21) Appl. No.: 15/809,419

(22) Filed: Nov. 10, 2017

(51) Int. Cl. G06F 1/32

(52) U.S. Cl. CPC G06F 1/3206; G06F 1/3287; G06F 1/324

(57) ABSTRACT

A processor is throttled based on accumulated combined current measurements from a plurality of processor cores. The processor monitors activity current levels at each processor core, either directly or indirectly by monitoring specified events at the processor cores. The processor combines (e.g., averages) the activity current levels over a specified duration to determine a combined activity current value (CCV), and compares the CCV value to a threshold, wherein the threshold is based on the maximum current limit of the processor. In response to the CCV exceeding the threshold, the processor throttles one or more of the processor cores, thereby reducing the activity current level at the throttled processor cores and ensuring that the processor operates within its specified current limits.

### BACKGROUND

The operation of a processor is constrained by physical limitations of the materials used to form the processor. Exceeding these physical limitations can cause unpredictable or undesirable operation of the processor's circuits, can damage the circuits themselves, or can shorten the useful life of the processor. Accordingly, to ensure that the physical limitations are not exceeded, a typical processor is configured to operate within a specified current limit. In particular, the processor sets the frequency of the processor clock, the processor reference voltages, and other parameters so that the current generated by one or more modules of the processor is not expected to exceed the current limit for more than a threshold amount of time. However, because the processor is likely to experience variable and unpredictable workloads, and therefore consume variable and unpredictable levels of current, a typical processor is designed to operate well below the current limit. While providing this operating margin ensures that temporary current excursions from heavy workloads do not exceed the current limit, such a large operating margin places an undesirable limit on overall processor performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor that throttles performance based on accumulated combined current measurements from a plurality of processor cores in accordance with some embodiments.

FIG. 2 is a block diagram of a combined activity current monitor of the processor of FIG. 1 in accordance with some embodiments.

FIG. 3 is a diagram illustrating an example of employing a combined activity current to reduce the amount of throttling at the processor of FIG. 1 in accordance with some embodiments.

FIG. 4 is a flow diagram of a method of throttling a processor based on accumulated combined current measurements from a plurality of processor cores in accordance with some embodiments.

### DETAILED DESCRIPTION

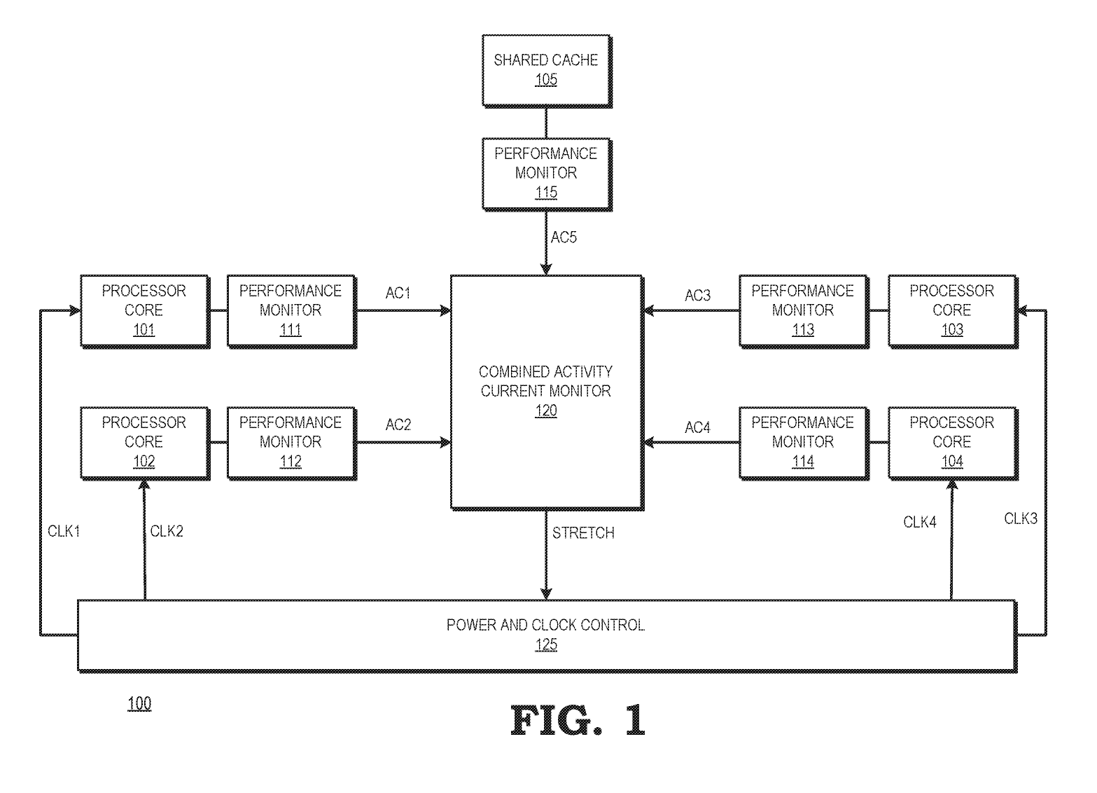

FIGS. 1-4 illustrate techniques for throttling a processor based on accumulated combined current measurements from a plurality of processor cores. The processor monitors activity current levels at each processor core, either directly or indirectly by monitoring specified events at the processor cores. The processor combines (e.g., averages) the activity current levels over a specified amount of time to determine a combined activity current value (referred to herein as the CCV). The processor then compares the CCV value to a threshold, wherein the threshold is based on the maximum current limit of the processor. In response to the CCV exceeding the threshold, the processor throttles one or more of the processor cores, thereby reducing the activity current level at the throttled processor cores and ensuring that the processor operates within its specified current limits. By throttling the processor cores based on the CCV, rather than based on an individual activity current value, overall throttling at the processor is reduced. Relatedly, throttling the processor cores based on the CCV allows each individual processor core to operate closer to the maximum current limit, improving processor performance.

FIG. 1 illustrates a processor 100 in accordance with some embodiments. The processor 100 is generally configured to execute sets of instructions to carry out tasks on behalf of an electronic device. Accordingly, the processor 100 is configured to be incorporated into any of a variety of electronic devices, such as a desktop or laptop computer, a server, a tablet, a smartphone, a gaming console, and the like. In the depicted example embodiment, the processor 100 includes four processor cores, designated processor core 101, processor core 102, processor core 103, and processor core 104, and collectively referred to herein as processor cores 101-104.

Each of the processor cores 101-104 includes at least one instruction pipeline to execute program instruction threads. In particular, each instruction pipeline is configured to fetch instructions, decode each fetched instruction into one or more operations, dispatch the operations to one or more execution units, and retire instructions whose operations have completed execution. For purposes of description, the activities a processor core performs to execute instructions are generally referred to as tasks, and the number of tasks being performed by the processor core are referred to herein as the activity level of the processor core. As will be appreciated by one skilled in the art, the activity level of a processor core varies based on the characteristics of the set of instructions being executed by the processor core. For example, some sets of instructions require the processor core to perform a relatively high number of tasks in a short amount of time, such as requiring some combination of a high number of mathematical calculations, accessing memory structures, communicating with input/output devices, and the like. For these sets of instructions, the activity level of the processor core will be relatively high. In contrast, some sets of instructions require a relatively small number of tasks to be executed by the processor core, and therefore the activity level of the processor core will be relatively low.

To control the rate at which the processor cores 101-104 perform tasks, each of the processor cores 101-104 is supplied with a corresponding clock signal, designated CLK1, CLK2, CLK3, and CLK4, respectively. Each of the processor cores 101-104 employs its corresponding clock signal to synchronize operations of its synchronous logic elements. The frequencies of the clock signals CLK1-CLK4 thus govern the rate at which the processor cores 101-104 perform their corresponding tasks. The amount of current generated by a processor core, referred to herein as the processor core's activity current, is a function of the activity level of the processor core (the number of tasks the processor core is performing) and the frequency of the processor core's clock signal (the rate at which the processor core can execute the tasks). As explained further below, the processor 100 is generally configured to monitor a combined activity current for the processor cores 101-104 and, in response to the combined activity current exceeding a threshold, to throttle one or more of the processor cores 101-104 by lowering the frequency of one or more of the clock signals CLK1-CLK4. The processor 100 thereby ensures that it operates within specified current limits.

In the example embodiment of FIG. 1, the processor 100 includes a shared cache 105, which is configured to cache data for the processor cores 101-104. In some scenarios, the storage and retrieval of data at the shared cache 105 generates a relatively large amount of current that cannot be directly measured via the activity levels of the processor cores 101-104. Accordingly, the processor 100 separately monitors the activity current at the shared cache 105, and employs the activity current at the shared cache 105 to generate the CCV as described further herein.

To monitor the activity currents at the processor cores 101-104, the processor 100 employs a set of four performance monitors, designated performance monitor 111, performance monitor 112, performance monitor 113, and performance monitor 114, collectively referred to as performance monitors 111-115. Each of the performance monitors 111-115 is configured to identify the activity current at a corresponding one of the processor cores 101-104 and the shared cache 105. In the depicted embodiment, the performance monitor 111 identifies the activity current at processor core 101, the performance monitor 112 identifies the activity current at processor core 102, the performance monitor 113 identifies the activity current at processor core 103, the performance monitor 114 identifies the activity current at processor core 104, and the performance monitor 115 identifies the activity current at the shared cache 105.

In some embodiments, the performance monitors 111-115 identify the corresponding activity current indirectly by identifying the occurrence of specified events, and then calculating the activity current based on a known or predicted relationship between the identified events and an activity current value or values corresponding to the identified events. Examples of such events include cache accesses, cache misses, fetching of specified types of instructions, dispatch of specified types of operations, and the like. In other embodiments, the performance monitors 111-115 employ one or more current sensors to directly measure activity current at the corresponding processor core. In still other embodiments, the performance monitors 111-115 identify the activity current at the corresponding processor core based on a combination of current sensors and identified events.

To throttle the processor cores 101-104 based on the activity currents, the processor 100 employs a combined activity current monitor (CCM) 120 and a power and clock control module (PM) 125. The CCM 120 is generally configured to identify a combined activity current value based on the activity currents identified by the performance monitors 111-114. To illustrate, each of the performance monitors 111-115 generates a signal, designated AC1, AC2, AC3, AC4, and AC5 (collectively referred to as AC1-AC5), respectively, indicating the activity current at the corresponding processor core. The CCM 120 receives the signals AC1-AC5 and combines the indicated activity currents to determine the CCV. For example, in some embodiments the CCM 120 determines the CCV by averaging the indicated activity currents. The CCM 120 compares the CCV to an activity current threshold (ACT), wherein the ACT is based on the specified current limits for the processor 100. Based on the comparison, the CCM 120 sets the state of a control signal designated STRETCH, that controls the clock frequency of one or more of the clock signals CLK1, CLK2, CLK3, and CLK4, as described further herein. In particular, in response to the CCV exceeding the ACT, the CCM 120 asserts the signal STRETCH to reduce the frequency of one or more of CLK1, CLK2, CLK3, and CLK4, thereby reducing the activity current at one or more of the processors 101-104 and ensuring that the processor 100 does not exceed the specified current limits.

The PM 125 is generally configured to control the power states for the processor cores 101-104 based on the state of the signal STRETCH. As used herein, a power state of a processor core refers to a specified state of the processor core wherein one or more parameters of the processor core, such as a clock frequency, reference voltage, and the like are set such that the processor core consumes less than a specified amount of power relative to other power states. Examples of power states include an active state, wherein a processor core executes operations at a normal rate, and a low-power state, wherein the processor core executes operations at a lower rate, or does not execute operations but maintains stored data. In the example of FIG. 1, the PM 125 is configured to set the power state for each of the processor cores 101-104 by changing the frequencies for the clock signals CLK1, CLK2, CLK3, and CLK4. For example, the PM 125 reduces or lowers the power state of the processor core 101 by reducing the frequency of the clock signal CLK1, and increases or raises the power state of the processor core 101 by increasing the frequency of the clock signal CLK1. In some embodiments, the PM 125 changes the power state of the processor cores 101-104 in other ways such as by changing one or more reference voltages applied to the processor cores 101-104, either instead of or in addition to changing the frequencies of the clock signals CLK1, CLK2, CLK3, and CLK4.

As noted above, the PM 125 sets the power state for each of the processor cores 101-104 based on the state of the signal STRETCH. Thus, if the SIGNAL stretch is in a negated state, indicating that the CCV is below the ACT, the PM 125 maintains the clock signals CLK1, CLK2, CLK3, and CLK4 at a relatively high frequency. In response to assertion of the signal STRETCH, the PM 125 reduces the frequency of at least one of the clock signals CLK1, CLK2, CLK3, and CLK4, thereby reducing the activity level at the corresponding processor cores. In some embodiments, the PM 125 changes the power state of each of the processor cores 101-104 equally, by changing the frequency of each of the clock signals CLK1, CLK2, CLK3, and CLK4 by the same amount (e.g. reducing the frequency of each clock signal by the same percentage).

In other embodiments, the PM 125 selects a subset of the processor cores 101-104 and changes the power state only of the processor cores in the selected subset. The PM 125 selects the subset of processor cores based on any of a variety of criteria, such as the individual activity currents at the processor cores 101-104, priority values associated with threads executing at the processor cores 101-104, and the like. In some embodiments, the PM 125 is not a single module, but instead each of the processor cores 101-104 is associated with a different PM, and the CCM 120 provides an individual stretch control signal to each of the different PMs. The CCM 120 thereby individually changes the frequencies of each of the clock signals CLK1, CLK2, CLK3, and CLK4 according to the corresponding processor core's contribution to the combined activity current. Thus, for example, if the processor core 102 contributes more to combined activity current than processor core 101, the CCM 120 reduces the frequency of CLK2 by a greater amount than the frequency of CLK1.

It will be appreciated that the techniques described herein can be applied to processor configurations other than the embodiment of FIG. 1. For example, in some embodiments the CCM 120 determines a combined activity current based at least in part on currents generated by modules other than processor cores and caches, such as memory controllers, I/O controllers, bus controllers, graphics processing units (GPUs) and the like. Further, in some embodiments the PM 125, based on the combined activity current, changes the clock frequency for clock signals provided to any of the above-referenced modules. Moreover, in some embodiments one or more of the above-referenced modules are located on different integrated circuit dies or in different integrated circuit packages.

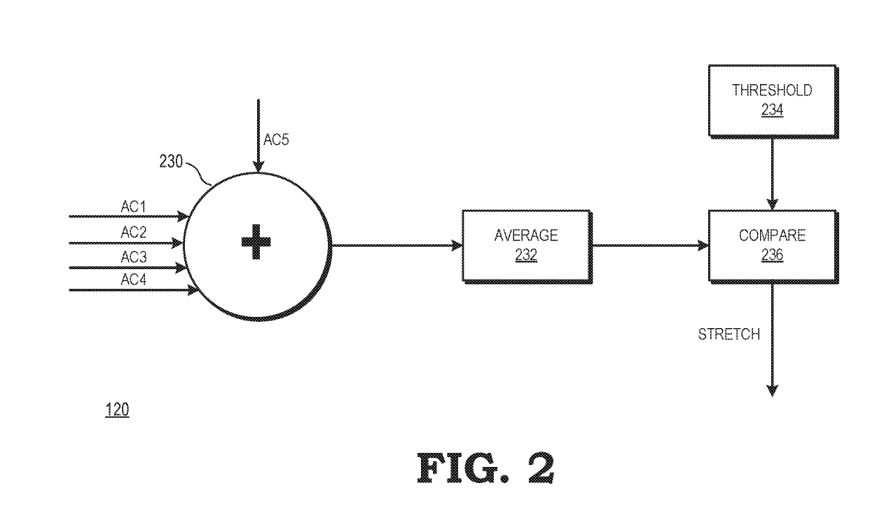

FIG. 2 illustrates a block diagram of the CCM 120 in accordance with some embodiments. In the illustrated example, the CCM 120 includes an accumulator 230, an averaging module 232, a threshold register 234, and a compare module 236. The accumulator 230 is configured to receive the signals AC1-AC5, indicating values for the activity levels at the processor cores 101-104 and the shared cache 105. The accumulator 230 adds the values together to identify an accumulated activity value. In some embodiments the accumulator 230 is configured to add the values for the activity levels over a specified period of time (e.g., 1 microsecond) to ensure that relatively brief current excursions at the processor cores 101-104 and the shared cache 105 do not cause unneeded throttling of the processor cores 101-104.

The averaging module 232 is configured to receive the accumulated activity value and divide the accumulated activity value by the number of the processor cores 101-104 and shared cache 105 that are active, thereby generating an average activity value. Thus, in some scenarios, such as when one or more of the processor cores 101-104 is idle or in sleep state, the divisor applied by the averaging module 232 is fewer than the total number of processor cores 101-104 and the shared cache 105.

The threshold register 234 is configured to store a threshold value indicative of a threshold activity current level. In some embodiments, the threshold value is set by the processor 100 to indicate a specified maximum activity current level, such that if the average activity current for the processor 100 were to exceed the maximum activity current for a threshold amount of time, the processor 100 would be damaged or experience unpredictable operations.

The compare module 236 is configured to compare the average activity value generated by the averaging module 232 to the threshold value stored at the threshold register 234. When the average activity value is less than the threshold value, the compare module 236 maintains the signal STRETCH in a negated state, thereby preventing throttling of the processor cores 101-104 due to activity level. In response to the average activity value exceeding the threshold, the compare module 236 asserts the signal STRETCH, thereby throttling one or more of the processor cores 101-104 and reducing the activity current at the processor 100.

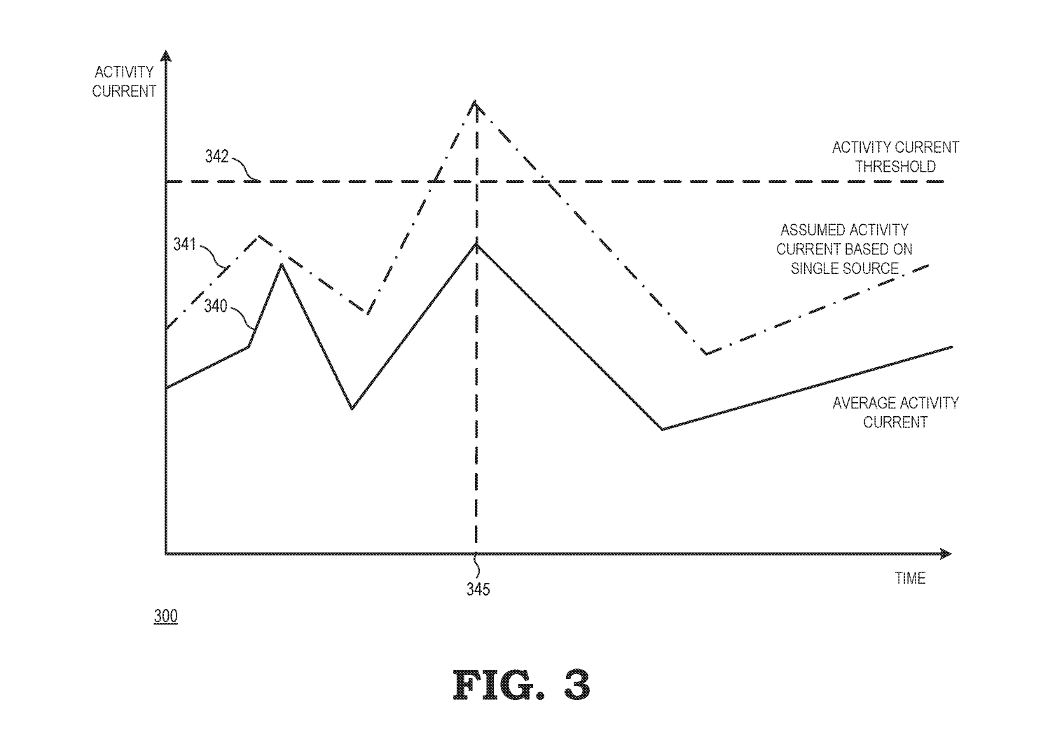

FIG. 3 illustrates a diagram 300 that depicts an example of employing a combined activity current to reduce throttling at the processor 100 in accordance with some embodiments. In the illustrated example, diagram 300 includes an x-axis that represents time and a y-axis that represents activity current. In addition, diagram 300 depicts three curves, designated curve 340, curve 341, and curve 342. Curve 340 represents the average activity current value generated by the averaging module 232 (FIG. 2). Curve 342 represents the threshold value stored at the threshold register 234, and thus is also referred to herein as “threshold 342”.

Curve 341 represents the assumed activity current if the activity current were identified at only one of the processor cores 101-104. That is, curve 341 represents a “single source” configuration under which the processor 100 is not directly identifying the combined activity current at all of the processor cores 101-104 and the shared cache 105. Under such a single source configuration, to prevent the combined activity current from exceeding the threshold, the processor 100 assumes that each of the processors 101-104 and the shared cache 105 generates activity current at least equal to that of the activity current measured at the single source. As illustrated by curve 341, this assumption results in higher activity current values than the average activity current value depicted by curve 340. Thus, under the single source configuration the processor 100 is likely to throttle the processor cores 101-104 more often than under the configuration where the processor 100 employs a combined activity current. For example, at time 345 the activity currents at the processor cores 101-104 and the shared cache 105 are such that, under the single source configuration, the assumed activity current is greater than the threshold 342, which would require the processor 100 to throttle at least one of the processor cores 101-104. However, the average activity current value at time 345 is less than the threshold 342, so the processor 100 does not throttle any of the processor cores 101-104. Thus, throttling the processor cores 101-104 based on combined activity currents rather than on a single source is likely to reduce overall throttling. In addition, throttling based on combined activity currents allows each of the processor cores 101-104 to operate at a point closer to the threshold 342, improving processor performance.

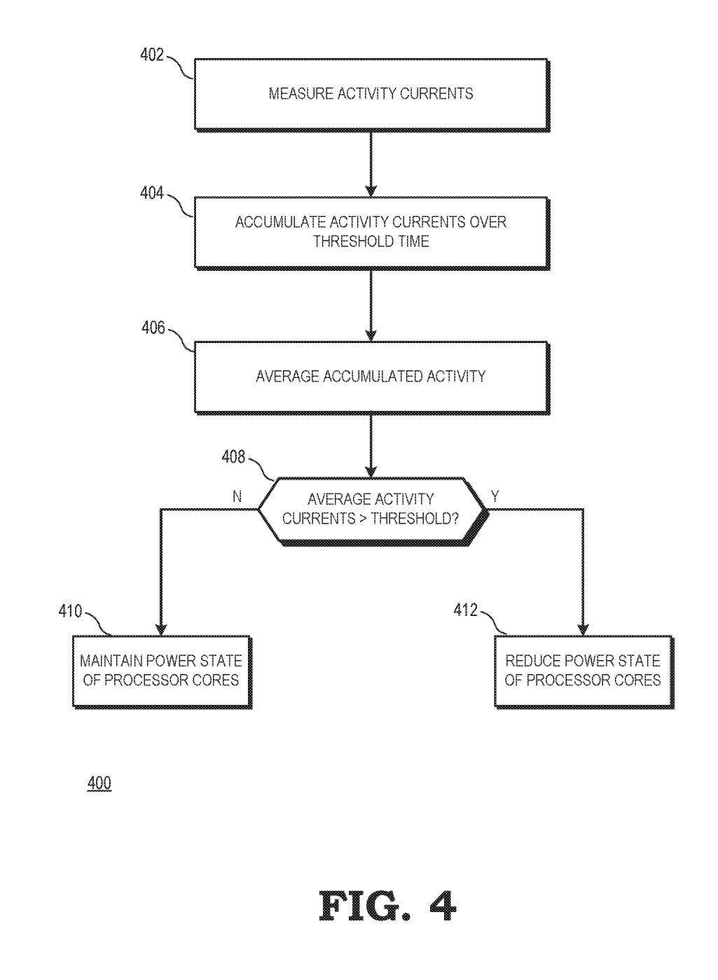

FIG. 4 is a flow diagram of a method 400 of throttling processor cores based on combined activity currents in accordance with some embodiments. The method 400 is described with respect to an example implementation at the processor 100. At block 402 the performance monitors 111-115 (FIG. 1) identify the activity currents at the processor cores 101-104 and the shared cache 105. At block 404 the accumulator 230 (FIG. 2) accumulates the identified activity currents over a threshold amount of time. At block 406 the averaging module 232 averages the activity currents based on the accumulated activity currents provided by the accumulator 230.

At block 408 the compare module 236 determines whether the average activity current value is greater than the threshold value stored at the threshold register 234. If not, the method flow moves to block 410 and the compare module 236 maintains the STRETCH signal in a negated state. The negated state of the STRETCH signal in turn causes the PM 125 (FIG. 1) to maintain the power state of each of the processor cores 101-104.

Returning to block 408, if the compare module 236 determines that the average activity current value is greater than the threshold value, the method flow moves to block 412 and the compare module 236 asserts the STRETCH signal. In response, the PM 125 reduces the clock frequency of one or more of the clock signals CK1, CK2, CK3, and CK4, thereby changing the power state of the corresponding ones of the processor cores 101-104.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
measuring, at a processor, a corresponding first activity current for each processor core of a plurality of processor cores of the processor to identify a first plurality of activity currents;
identifying, at the processor, a first combined activity current value based on the first plurality of activity currents; and
in response to the first combined activity current value exceeding a threshold, changing a power state of at least one of the plurality of processor cores.

2. The method of claim 1, wherein identifying the first combined activity current value comprises identifying the first combined activity current value based on an average of the first plurality of activity currents.

3. The method of claim 2, wherein identifying the first combined activity current value comprises identifying the first combined activity current value based on the average of the first plurality of activity currents over a threshold amount of time.

4. The method of claim 1, wherein changing the power state comprises changing a frequency of a clock signal of the at least one of the plurality of processor cores.

5. The method of claim 1, wherein changing the power state comprises placing the at least one of the plurality of processor cores in a low power state and maintaining another processor core of the plurality of processor cores in an active state.

6. The method of claim 1, wherein:
identifying the first combined activity current value comprises identifying the first combined activity current value at a first time; and
the method further comprises:
measuring a corresponding second activity current for each processor core of the plurality of processor cores to identify a second plurality of activity currents;
at a second time, identifying a second combined activity current value based on the second plurality of activity currents; and
in response to the second combined activity current value being below the threshold, changing the power state of the at least one of the plurality of processor cores.

7. The method of claim 1, wherein changing the power state of the at least one of the plurality of processor cores comprises changing a power state of each of the plurality of processor cores.

8. The method of claim 1, wherein changing the power state of the at least one of the plurality of processor cores comprises:
identifying a subset of the plurality of processor cores, wherein a number of processor cores identified for the subset is based on an amount by which the first combined activity current value exceeds the threshold; and
changing a power state of each of the subset of the plurality of processor cores.

9. The method of claim 1, further comprising:
measuring a second activity current at a shared cache; and
wherein identifying the first combined activity current value comprises identifying the first combined activity current value based on the first plurality of activity currents and the second activity current.

10. A method, comprising:
identifying an average of a plurality of activity currents at a processor, wherein each activity current of at least a subset of the plurality of activity currents corresponds to a different processor core of the processor; and
throttling at least one processor core of the processor based on the average.

11. The method of claim 10, wherein at least one of the plurality of activity currents corresponds to a shared cache of the processor.

12. A processor, comprising:
a plurality of processor cores;
a plurality of performance monitors configured to identify a first plurality of activity currents, each of the first plurality of activity currents corresponding to a different one of the plurality of processor cores;
an activity current monitor configured to identify a first combined activity current value based on the first plurality of activity currents; and
a power control module configured to change a power state of at least one of the plurality of processor cores in response to the first combined activity current value exceeding a threshold.

13. The processor of claim 12, wherein the activity current monitor is configured to identify the first combined activity current value based on an average of the first plurality of activity currents.

14. The processor of claim 13, wherein the activity current monitor is configured to identify the first combined activity current value based on the average of the first plurality of activity currents over a threshold amount of time.

15. The processor of claim 12, wherein the power control module is configured to change the power state by changing a frequency of a clock signal of the at least one of the plurality of processor cores.

16. The processor of claim 12, wherein the power control module is configured to change the power state by placing the at least one of the plurality of processor cores in a low power state and maintaining another processor core of the plurality of processor cores in an active state.

17. The processor of claim 12, wherein:
the plurality of performance monitors is configured to identify the first combined activity current value at a first time;
the plurality of performance monitors is configured to identify a second plurality of activity currents at a second time, each of the second plurality of activity currents corresponding to a different one of the plurality of processor cores;
the activity current monitor is configured to identify a second combined activity current value based on the second plurality of activity currents; and
the power control module is configured to change the power state of the at least one of the plurality of processor cores in response to the second combined activity current value being below the threshold.

18. The processor of claim 12, wherein the power control module is configured to change the power state by changing a power state of each of the plurality of processor cores.

19. The processor of claim 12, wherein the power control module is configured to change the power state by:
identifying a subset of the plurality of processor cores, wherein a number of processor cores identified for the subset is based on an amount by which the first combined activity current value exceeds the threshold; and
changing a power state of each of the subset of the plurality of processor cores.

20. The processor of claim 12, further comprising:
a shared cache;
wherein the plurality of performance monitors is configured to measure a second activity current at the shared cache; and
wherein the activity current monitor is configured to identify the first combined activity current value based on the first plurality of activity currents and the second activity current.
